(19) United States
(12) Patent Application Publication
(10) Pub. No.: US 2006/0104333 A1
(43) Pub. Date: May 18, 2006

(54) Acknowledgment for a time division channel

(75) Inventors: Bradley J. Rainbolt, Sunrise, FL (US); Stephen R. Carsello, Plantation, FL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/992,156

(22) Filed: Nov. 18, 2004

(51) Int. Cl. H04B 1/713

(52) U.S. Cl. 375/132

(57) ABSTRACT

A communication unit (101) and corresponding methods are arranged and constructed to detect acknowledgment messages as an Originator or respond with an acknowledgment message as a Target on a time division channel. The communication unit includes a transceiver (201) configured to support air interfaces (113, 115) with other communication (103, 105) units according to frequency hopping patterns and a controller (203) cooperatively controlling the transceiver to, for example, send a call setup message identifying a target communication unit and a pseudo-random frequency hopping pattern; and to determine whether an acknowledgment message from the target communication unit is present in a signal received according to the pseudo-random frequency hopping pattern.

### FIELD OF THE INVENTION

This invention relates in general to communication systems, and more specifically to methods and apparatus for detecting acknowledgment messages when setting up calls or the like between communication units.

### BACKGROUND OF THE INVENTION

Communication systems and call setup procedures in such systems are known. Many communication systems, such as cellular telephone systems, have dedicated control channels that facilitate call setup including explicit acknowledgment processes and messages. Acknowledgment messages and processes allow a target communication unit to respond to an attempt to establish a call or otherwise communicate with the target unit. Using acknowledgment processes allows for smoother and more efficient system operation, since the system infrastructure or originating communication unit will know that a desired target unit is available often more quickly and with a greater degree of certainty.

In simple communication systems, such as direct unit to unit communication there may not be an explicit acknowledgment process. If a user of a target or another communication unit responds that implicitly serves as an acknowledgment but may result in wasting systems resources. Some protocols have been proposed in the Industrial, Scientific, and Medical (ISM) frequency band that dedicate a frequency for sending acknowledgment indications, however this approach may be susceptible to interference from other units on the dedicated frequency.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various exemplary embodiments and to explain various principles and advantages all in accordance with the present invention.

FIG. 1 depicts, in a simplified and representative form, a system level diagram of a communications system including communication units;

FIG. 2 depicts, in a simplified and representative form, a communications unit suitable for utilizing various embodiments;

FIG. 3 illustrates in a simplified and representative form a sequence of communications slots including Preamble, Sync and ACK slots suitable for use in the communication unit of FIG. 2;

FIG. 4 depicts a sequence of communications as sent and received in one embodiment;

FIG. 5 shows a Sync slot structure in one embodiment;

FIG. 6 depicts a table showing contents of Sync Field ID data;

FIG. 7 shows details of an ACK slot;

FIG. 8 shows contents of an ACK message;

FIG. 9 illustrates an error protection process for the ACK message;

FIG. 10 depicts performance results from a simulation for multiple Targets sending the ACK message;

FIG. 11 illustrates a situation with two Targets having a time difference between the two Targets;

FIG. 12 illustrates a timing diagram from an Originator and Target perspective;

FIG. 13 shows a flow chart of a timing offset process; and

FIG. 14 depicts performance results from a simulation of various time offsets for two Targets.

### DETAILED DESCRIPTION

In overview, the present disclosure concerns communications systems that provide service to communications units or more specifically a user thereof operating therein. More particularly various inventive concepts and principles embodied in methods and apparatus for setting up a call between an originator or originating communication unit and one or more target or target communication units including novel and inventive techniques for initiating a call setup and acknowledging the call setup, i.e. attempt to originate a call, are discussed and described.

The term communication device or communication unit may be used interchangeably with subscriber unit, wireless subscriber unit, wireless subscriber device or the like. The communication devices of particular interest are those providing or facilitating, for example, voice/audio communications services and suitable to employ the concepts and principles further noted below. Such devices or units utilizing channels without dedicated continuous control or setup communication streams or channels can advantageously benefit from the concepts and principles described. For example communication units operating in ad-hoc networks or in direct unit to unit communications and a corresponding connection in a half duplex mode can advantageously benefit from the disclosed techniques.

As further discussed below, various inventive principles and combinations thereof are advantageously employed to provide closed loop feedback to an originating communication unit from one or more target communication units, e.g. an acknowledgment message and associated information. Various exemplary embodiments comprise apparatus and processes facilitating one or more of sending or transmitting a call setup message, detecting the call setup message and relevant information at one or more target communication units, responding with acknowledgment messages from the one or more target communication units, and determining at the originating communication unit whether one or more of the target communication units have responded. Thus a call can be setup between an originating unit and various target units with high reliability without undue degradation in voice or audible signals or undue latency in establishing a connection provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and general purpose or digital signal processors or other integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the exemplary embodiments.

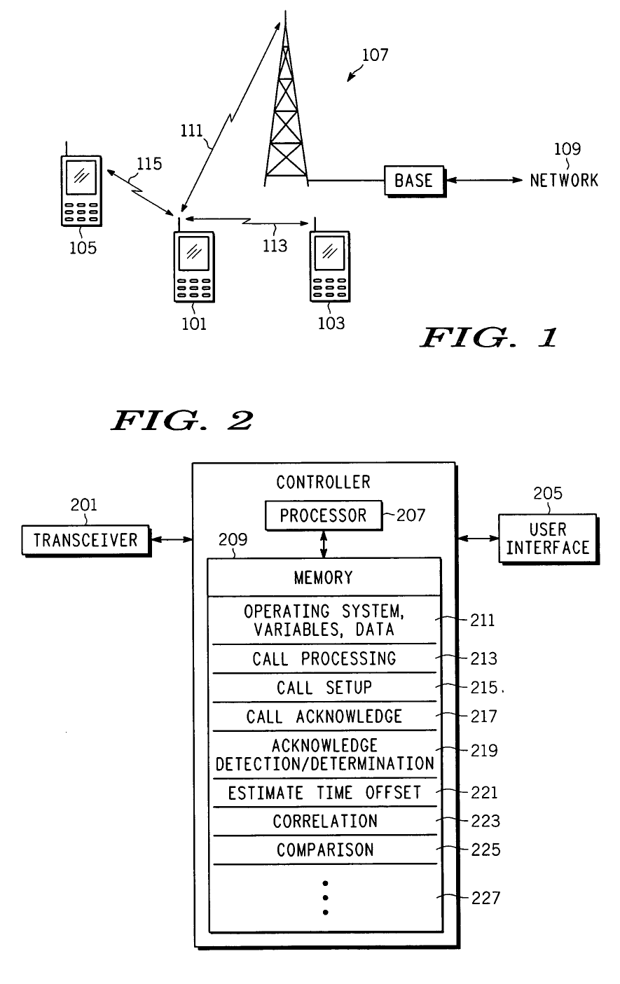

Referring to FIG. 1, a simplified and representative system level diagram of a communications system with a multiplicity of communication units (three depicted) will be discussed and described. FIG. 1 depicts communication units 101, 103, 105 that are wireless communication units and a system infrastructure or base station 107 that may be further coupled to a network 109, such as the public switched telephone network or Internet. The communications units can communicate with the base station via the signals or air interfaces generally represented as 111 and with each other via the signals or air interfaces generally represented as 113, 115. A given communication unit, e.g. unit 101 can communicate with one or many other communication units, e.g. units 103, 105 through direct connections or air interface signals 113, 115. The one unit to many units communication may be referred to as a group call.

In one or more exemplary embodiments the system operates in a half-duplex or according to a half-duplex protocol, i.e. where the communication units are capable of either transmitting or receiving but only one of these functions at any given time. Further various inventive concepts and principles are employed to provide acknowledgment indications or messages to an originating communication unit when an attempt to set up a call with other or target communication units is undertaken. These acknowledgment messages will notify the originating communication unit that one or more target communication units are within range and that a successful connection has been made and may provide additional information regarding a target unit, e.g. whether a particular type of call is supported. Generally the communication units and base station are known other than the inventive concepts and principles discussed further below.

Referring to FIG. 2, a simplified and representative block diagram according to various embodiments of a communication unit, such as communication unit 101, 103, 105 that is suitable for utilizing various embodiments of apparatus and methods to facilitate communications, including call setup and acknowledgements will be discussed and described. In one or more exemplary embodiments the communication unit is arranged and constructed to detect acknowledgment messages from one or a plurality of other communication units on a time division channel. The communication unit includes a transceiver 201 that is configured to support an interface or air interfaces with other communication units, such as the communication units 103, 105 or base station 109. The transceiver may be a radio frequency transceiver in wireless applications, will vary with the interface that is supported, and is generally known and available other than the applications and modifications, if any, as noted further below.

In certain embodiments, the air interface is a frequency hopping interface, i.e. uses a physical channel and corresponding protocols that rely on frequency hopping patterns. For example, the frequency hopping patterns can be a pseudo-random frequency hopping pattern where a carrier frequency for the connection or during the communication or call is periodically changed among a number of frequencies in a pseudo-random manner, e.g. such that all frequencies have a similar probability of being used.

The transceiver 201 is coupled to a controller and signal processor (hereinafter controller) 203 and the controller 203 is further coupled to an interface, such as a user interface 205. The user interface 205 includes various generally known and widely available entities suitable for effecting interaction with a user. These entities may include, for example, a speaker or earpiece, a microphone, and a display or visual output device, input device such as keyboard, keypad, joystick, etc. or the like. The controller 203 is generally responsible for effecting an interaction between the unit and a user or other consuming device, e.g. computer or the like, command and control of the transceiver and unit, as well as much of any base band signal processing.

The controller 203 may include or perform signal processing functions, such as vocoder processing, cryptography, and a channel procedure or processing. The controller 203 further comprises a processor 207 coupled to a memory 209 that performs the various functions of the controller. The processor 207 can be comprised of one or more general purpose microprocessors or digital signal processors, or the like, and various supporting circuitry, such as integrated circuits including application specific integrated circuits where such devices are widely available and generally known to those of ordinary skill. The specific arrangement is likely to be communication unit and feature specific and depend on processor capacity that may be required for a given system and so forth. Note that the above noted signal processing functions can be implemented in or assisted or controlled by the processor or portions thereof.

The memory 209 includes software or firmware instructions or routines that when executed by the processor result in the processor or controller performing the task(s) the controller or processor is responsible for. The memory also includes data or databases and variables that may be required to perform its duties. The memory includes an operating system, data and variables 211, a call processing routine 213, a call setup routine 215, a call acknowledgement routine 217, acknowledgment detection and determination routines 219, time offset estimation routines 221 including correlation 223 and comparison 225 routines as well as various other applications, databases, and routines 227, such as user interface drivers, phone books, applications, etc., that will be evident to one of ordinary skill and that may vary from unit to unit.

The communication unit of FIG. 2 is arranged and constructed to initiate calls via the call setup routine 215, acknowledge calls or call setup messages via the call acknowledgment routine 217 that it receives, and to detect acknowledgment messages via the call acknowledgment detection and determination routine 219 on a time division channel and otherwise perform call processing via the routine 213. The transceiver 201 can be configured to support air interfaces with other communication units according to frequency hopping patterns and the controller when coupled to and cooperatively controlling the transceiver can send a call setup message and thereafter determine whether an acknowledgment message is received.

The call setup message identifies at least one and possibly a multiplicity, e.g. group, of target communication units and also indicates or specifies a frequency hopping pattern (e.g. by including information corresponding to the pattern) that in various embodiments is pseudo-random. The controller determines whether the acknowledgment message has been received from one or more target communication units, i.e. whether the message is present in a signal received according to the pseudo-random frequency hopping pattern. In certain embodiments the controller with transceiver is configured to determine whether the acknowledgment message is present in a signal received on a plurality of sequential frequency hops according to the pseudo-random frequency hopping pattern.

The communication unit or the controller cooperatively with the transceiver can be configured to send the call setup message during a first time period, e.g. one or more first time slots, on a predetermined frequency and then determine whether the acknowledgment message is present in a signal received during a second time period, e.g. one or a plurality of second time slots, each of the plurality of second time slots corresponding to a frequency determined by the pseudo-random frequency hopping pattern. The call setup message can identify a group of target communication units and the controller determine whether the acknowledgment message is present in a composite signal received according to the pseudo-random frequency hopping pattern. Note that the composite signal may comprise one or more signals from one or more of the group of target communication units.

In some embodiments it can be advantageous for the controller to determine or detect whether the acknowledgment message is present in the composite signal, where the composite signal further comprises a plurality of signals from a corresponding plurality of target communication units, with the acknowledgment message included in each of the plurality of signals.

The second time period can be related to the first time period by a time difference comprising a predetermined number of time slots and a time offset corresponding to a propagation delay between the communication unit and the at least one target communication unit. The controller can be configured to estimate the time offset via the routines 221 by correlating information using the correlation routines 223 corresponding to the signal as received during the second time period with a template corresponding to the acknowledgment message, where the correlating is performed over a time window selected to account for the propagation delay.

The correlation can provide a plurality of correlations and associated offsets and an estimated time offset can be selected as the associated offset corresponding to a largest correlation. The controller can be configured to compare using the routine 225 each of the plurality of correlations to a threshold and when the threshold is satisfied, to select the estimated time offset as the associated offset corresponding to the largest correlation and otherwise to select the estimated time offset as one of a default offset and a previously used offset. The time offset can be estimated for each of a plurality of sequential time slots.

The communication unit is also arranged and constructed to provide acknowledgment messages on a time division channel when the unit is one of the target communication units for a call setup message. In this instance the controller is coupled to and cooperatively controlling the transceiver to receive a call setup message, determine whether the call setup message identifies the communication unit and determine a pseudo-random frequency hopping pattern specified by the call setup message via the call processing routines, etc. 213; and when the call setup message identifies the communication unit send an acknowledgment message using the call acknowledgment routine 217 responsive to the call setup message, where the acknowledgment message is included in a signal that is transmitted according to the pseudo-random frequency hopping pattern.

In some embodiments the controller cooperatively controlling the transceiver is configured to receive the call setup message on a predetermined frequency during a first time period and send the acknowledgment message during a second time period comprising, for example, a sequence of consecutive time slots, where a frequency for the signal during each time slot is determined according to the pseudo-random frequency hopping pattern.

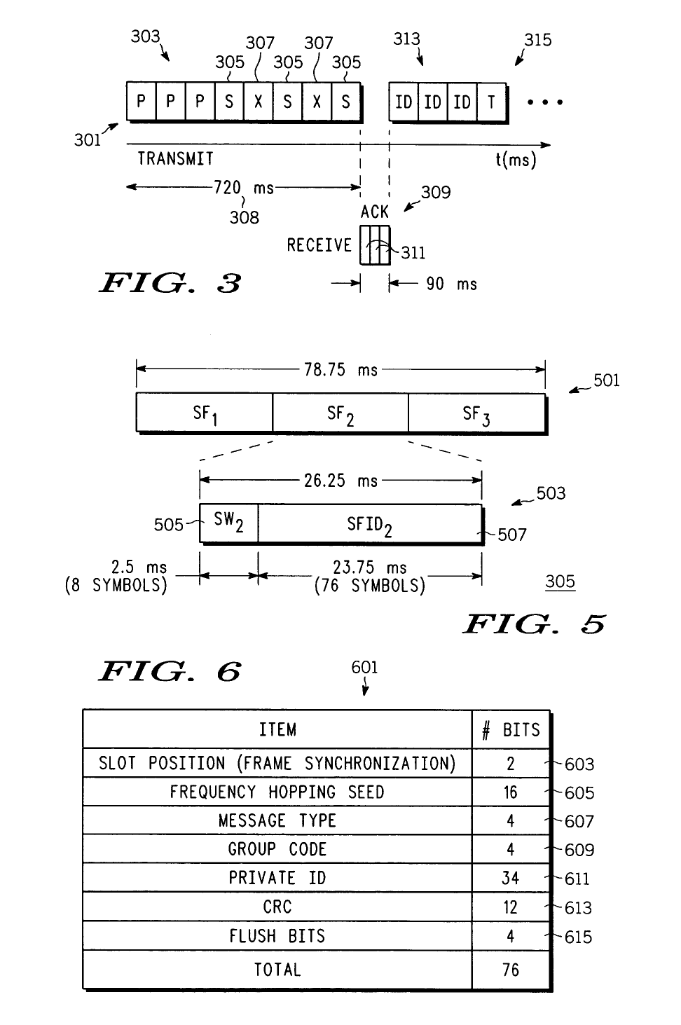

One exemplary protocol and system will be described and discussed and thus used to demonstrate by example various of the concepts and principles according to the invention. The exemplary protocol is used in various products available from Motorola, Inc. This will be described in more detail below with reference to FIG. 3 through FIG. 14.

A basic overview of some aspects of the exemplary protocol will be provided. The protocol supports half-duplex communications, i.e. one to one or one to many connections, such as communication unit to communication unit, e.g. portable or mobile-to-portable or mobile (without infrastructure) or mobile or portable to infrastructure or base station communications. In the discussions below the originating communication unit will be referred to alternatively as the Originator and the one or more target communication units will be referred to alternatively as Target(s). The protocol is or uses frequency hopping techniques or procedures, and is suitable for operating, for example, in the unlicensed Industrial, Scientific, and Medical (ISM) band at 902-928 MHz or various other bands as will be appreciated. In the discussions below, the time or time duration in which a given carrier frequency is used will be referred to as a “slot.” A slot is 30 ms for an acknowledgment transmission or message (ACK) and 90 ms for all other types of transmissions or messages.

One sequence of slots is shown in FIG. 3 for the Originator. A call is established or set up with the Originator transmitting or sending a call setup message 301 embodied, for example, as or in a pattern of Preamble (P) 303 and Sync (S) 305 slots, with blank slots (X) 307 inserted between the Sync slots. Note that the call setup message is sent during a first time period 308, e.g. in one embodiment during the time duration (9 slots total=720 ms) for the preamble slots 303 plus the Sync slots 305 and blank slots 307. The Target(s) if available, etc. sends and the Originator then receives an ACK frame (A) 309, which is 3 slots 311 of 30 ms each, or 90 ms total time duration.

As will be further discussed below in one embodiment the Preamble slots 303 as well as Sync slots 305 are sent or transmitted on a predetermined frequency that varies with each slot whereas the ACK frame 309, specifically each of the 3 ACK slots is sent on a frequency that is selected according to frequency hopping pattern that can be pseudo-random. Note that the ACK frame including the acknowledgment message is sent and thus available or present during a second time period that corresponds to the duration of the ACK frame 309, e.g. 90 ms. The second time period is in one embodiment related to the first time period by a time difference comprising a predetermined number of time slots, e.g. 9 slots with reference points chosen as the beginning of each time period or 4 with reference points chosen as the end of the first Sync frame and the beginning of the ACK frame, etc.

The Originator then proceeds to send 90 ms slots back to the Target, beginning with the Originators Private ID (ID) 313 in, for example, 3 slots, and then Traffic Slots (T) 315. The timing of the Target is essentially the opposite. That is, it is transmitting while the Originator is receiving, and is receiving while the Originator is transmitting.

Referring to FIG. 4 through FIG. 6, a brief description of synchronization will be provided. The preamble and Sync signals are used for synchronization. Synchronization can be challenging in the exemplary embodiment since there is no system to lock onto and track. In a traditional cellular-type system or the like, a forward channel, such as a control channel or the like provides a constant reference. In this embodiment for a direct communication, e.g. unit to unit connection, a reference can be established by the Originator using a preamble at the beginning of each transmission. The Target units can decode this preamble, and proceed to acquire frequency, symbol timing, and frame synchronization, all before actual traffic data appears on the channel. Generally the synchronization process should exhibit better sensitivity and robustness than a traffic communication, so that it is not a limiting performance barrier in the system.

FIG. 4 shows an example of the transmitter (Originator) 401 and receiver (Target) 403 operations during the call set-up process. At the beginning of each transmission, i.e., after each user initiation of call, e.g. push-to-talk (PTT), the transmitter sends a known preamble signal on each of three consecutive frequency hops, f₁, f₂, f₃, each hop having a dwell time or time duration of 90 milli-seconds (ms). This 90 ms interval includes transmit switching time, so the transmitter actually sends the preamble for slightly less than 90 ms on each hop. The receiver starts the call in stand-by mode, during which it is periodically scanning the preamble frequencies 405, e.g. three preamble frequencies, for the known preamble waveform. As the receiver's preamble detection interval increases or as the number of preamble frequencies is increased, the stand-by battery life of the receiver may decrease.

Note that the period with which the receiver wakes up to scan should be chosen so that the receiver is guaranteed to get a “clean” look at all three preamble transmissions, i.e. the receiver scans each of the three preamble frequencies during the time duration of one preamble slot. This effectively provides third-order diversity for the preamble detection process. The preamble frequencies f₁-f₃ should be known by the receiver, e.g. these are predetermined frequencies, and, in fact, the first six hop frequencies f₁-f₆ are known in this embodiment. Generally the preamble slot will contain a periodic waveform which repeats itself at a rate compatible with the receiver's preamble detection interval. One such waveform is generated by presenting an 8-FSK modulator with the following symbol pattern: [+4 +4 +4 +4 −4 −4 −4 −4]. Note that this data pattern repeats every 8 symbols, or every 2.5 ms at the exemplary data rate for this protocol. The preamble signal is a mechanism by which the receiver is brought out of stand-by mode. In addition, the preamble should provide sufficiently accurate frequency correction to the receiver, so that we may reliably detect the ensuing Sync slots.

The timing information provided by the preamble is very rough, i.e., it doesn't provide information about where we are in the slot, so it is only accurate to within about 90 ms (duration of a preamble slot). Slots designated f₄ through f₆ are referred to as Sync slots, which provide, among other things, symbol timing, frame timing, and frequency hopping synchronization, i.e. the balance of the synchronization. In the illustration shown here, the receiver has failed to detect the first two preamble slots, while successfully detecting the third and final preamble transmission f₃. Upon detection of the preamble, the receiver wakes up and scans each Sync slot frequency f_{4-f}₆ with an exemplary window of 180 ms at each frequency, until one or more Sync slots are successfully decoded. Note that the transmitter is dormant for 90 ms (see FIG. 3, X slot 307) after each of the first two Sync slot transmissions, so that the receiver is guaranteed to observe the entire Sync slot.

The Sync slots in addition to providing the rest of the synchronization can also provide the receiver with the following exemplary information: Group code and Private ID of a Target, Symbol and frame synchronization, Frequency hopping synchronization for the ensuing traffic (Frequency hopping seed), Message type, and further automatic frequency correction. Once a Sync slot is successfully decoded, the two units are completely synchronized, and the format of the ensuing traffic and/or control data is known. Note that the Sync slot may be repeated three times on three different frequencies, thereby providing third-order diversity to the Sync signal. Upon detection of the preamble signal, the Target unit should be accurately locked in frequency to the transmitter of the Originator. Upon receiving and decoding the ensuing Sync slots according to generally known techniques the Originator and Target units will be completely synchronized, and ready for data. One of the first exchanges is the ACK exchange 407 where the Target sends the ACK frame on three frequencies chosen according to the frequency hopping pattern, f_{HP}, and the Originator receives the frame according to f_{HP}. Thereafter the Originator sends or transmits its ID and data or traffic and the Target receives the same on frequencies according to the f_{HP}.

Referring to FIG. 5 an exemplary structure (contents and arrangement) of the Sync slot will be described. FIG. 5 shows the structure or contents of the Sync slot, which contains 3 Sync Fields (SF) 501. Each Sync Field, e.g. field 503 includes a Sync Word (SW) 505 and a Sync Field ID (SFID) 507 having a time and symbol duration as depicted. The Sync Word provides symbol timing for each Sync Field and is composed of the 8 symbol pattern [−7, −3, −7, −1 −3, −5, −5, −1 in one exemplary embodiment. The Sync Field ID is used to identify which of the 3 Sync Fields has been decoded, for the purpose of frame synchronization. In addition, the SFID 507 provides information about the group code and Private ID for Target units, frequency hopping pattern, and message type.

Referring to FIG. 6, a Table summarizes the contents 601 of the SFID, which contains a total of 76 bits prior to channel coding. As indicated the SFID contains a slot position 603 (value of 1, 2, or 3), frequency hopping seed 605 (value that provides state information for pseudo random number generator), message type 607, group code 609 (value specifies a group of units), private ID 611 (ID for a Target unit), a CRC value 613, and flush bits 615. The channel encoded symbols are passed through an approximately-square interleaver to break up error bursts as is known. Thus when an Originating communication unit sends a call setup message or initiates a call setup the resultant messages in Sync slots identify at least one and possible more Targets and specify or indicate a pseudo random frequency hopping pattern.

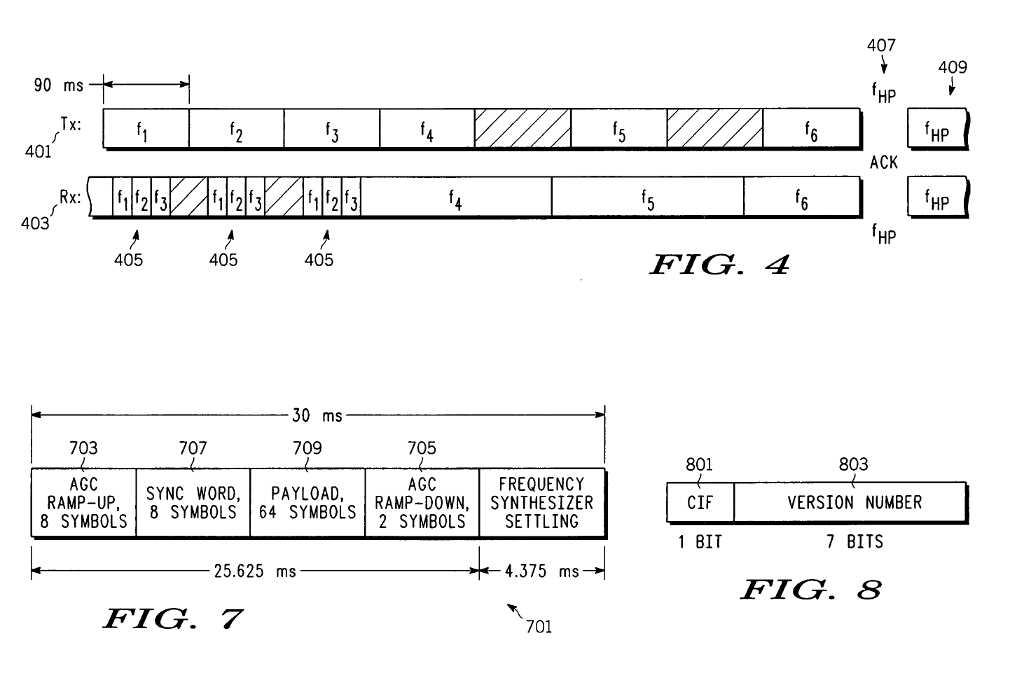

Referring to FIG. 7, the details of an ACK slot 701, such as one of the ACK slots 311 will be discussed and described. At the end of the 30 ms slot, there is a 4.375 ms interval for frequency synthesizer settling, which leaves 25.625 ms in which symbols are sent, or 82 symbols at 3200 symbols/sec. The block of 82 symbols consists of 8 AGC ramp-up symbols 703, 2 AGC ramp-down symbols 705, an 8-symbol Sync Word pattern 707 (505 from FIG. 5), and 64 symbols of payload or traffic 709. In the discussion below of this exemplary protocol, one-to-one calls will be referred to as “Private” while one-to-many calls will be referred to as “Non-Private.” In both Private and Non-Private Calls, the ACK message is used as an indicator that one or more Targets are in range. In Private Calls, the ACK message can contain additional information about the call connection.

In one or more exemplary embodiments, the ACK message consists of a field of 8 bits, as shown in FIG. 8. One bit is the Compatibility Indicator Flag (CIF) 801. It can be set to 1, for example if the Message Type is supported by the Target, and set to 0 otherwise. Generically speaking, some typical Message Types are voice, data, and short messages. The Message Type is a bit field sent from the Originator to the Target(s) in the Sync slots (see FIG. 6), and thus the Target knows the Message Type after decoding the information in the Sync slot. This may be important if the feature set supported by the protocol is expanded over time, and thus earlier generations of products may not support some of the Message Types implemented in the future.

Currently, the remaining 7 bits comprise a Version Number 803, indicating a version number or release of the protocol that the Target is using. The communication units can keep a database that tells which features are supported by each Version Number, if desired. This field could as well be used to communicate other information, such as received signal strength and the like if desired.

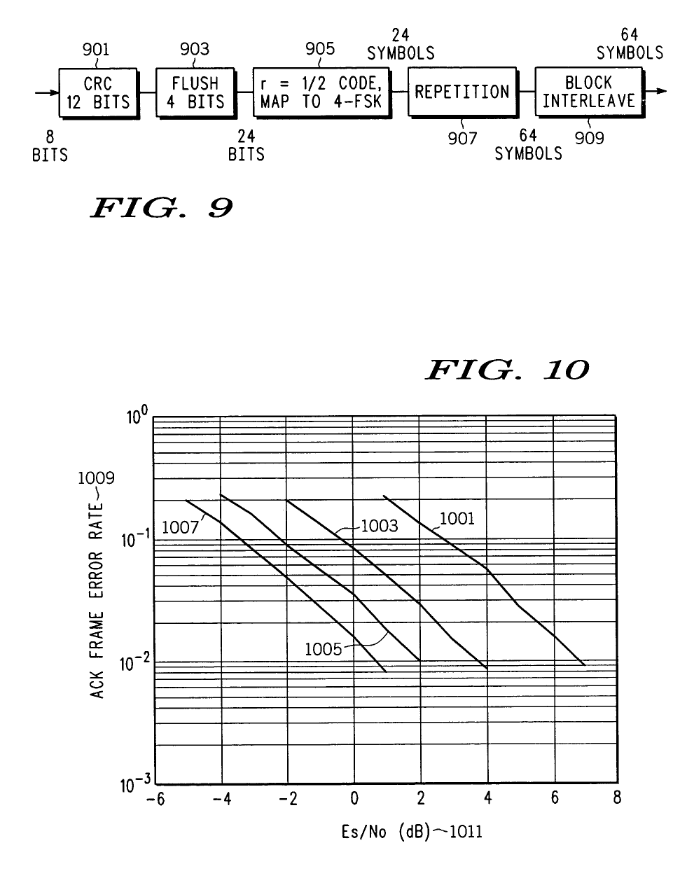

One error protection scheme or process where each process is generally known that can be applied to the exemplary ACK message of FIG. 8 is shown in FIG. 9. The field of 8 bits from FIG. 8 is first processed to generate and add a 12-bit CRC 901 and flushed with 4 zeros 903. Then a rate ½ convolutional code 905 is applied, and the bits are mapped to 4-FSK symbols. The symbols are then repeated 907, some repeated once and some repeated twice, to give a block of 64 symbols. Finally, those 64 symbols are block-interleaved 909 to form another 64-symbol block and thus provide the Payload 709 in FIG. 7.

From the ACK message when successfully received and decoded, the Originator receives the following information, given that the CRC check passes:
1) The connection was successful.
2) The Target does or does not support the type of Call, and the Version Number of the Target.

Referring to FIG. 10, simulation results will be discussed and described. These simulation results are for a Rayleigh fading channel at a speed of 3 mph. The plot shows curves for 1, 2, 3, and 4 Targets, 1001, 1003, 1005, 1007, respectively, with the “1 user” case equivalent to the Private ACK discussed above and the other curves for Non-private ACK situations further discussed below. In all cases, all Targets' signals arrived at the Originator with zero delay and zero frequency offset, and the correct timing was known at the Originator. In other words, the timing synchronization algorithm developed later was not used in this simulation. The curve shows the Frame Error Rate (FER) 1009 as a function of signal to noise (Eb/No=energy per bit/noise) 1011, which is the probability that the 8-bit ACK field is not decoded properly. In the next section, Non-Private ACK results will be compared to these results.

In Non-Private Calls, e.g. group calls, a plurality of Targets may respond or reply back to the Originator when a call setup is attempted. The task of decoding a composite signal at the Originator is more straightforward if the Targets all send a fixed pattern, without attempting to convey information such as the CIF and Version Number. Thus, when receiving a Non-Private call setup message, a Target will behave as follows
1) If the Message Type is supported, the Target will reply with the ACK message formed by setting the 8 information bits in FIG. 8 to all-ones, i.e. [1111, 1111], and sending the 64 output symbols formed by the error-protection scheme shown in FIG. 9.
2) If the Message Type is not supported, the Target will not reply.

One reason that the Targets may send the same ACK message will now be illustrated. First, consider the reception of a single M-FSK (multitone-frequency shift keyed) signal. A bank of M matched filters can be implemented and used in the receiver or receiving processes, each one correlating the received signal with one of the M tones. The mth matched filter output during the ith symbol interval is

$${Z}_{m} ( i ) = {\int }_{{iT}_{s}}^{( i + 1 ) {T}_{s}} r ( t ) cos ( 2 π {f}_{m} t ) ⅆ t$$

for m=0,1,. . . ,(M-1). In this equation, r(t) is the received signal, Tₛ is the symbol time, and fₘ is the mth frequency. Ideally, if f(i) is the M-FSK frequency during the ith symbol interval, the matched filter at f(i) will have a large signal component and a noise component, while the other matched filters only have a noise component. That is,

$${Z}_{m} ( i ) = \{ \begin{matrix}γ ( i ) S + {N}_{m} ( i ) , & {f}_{m} = f ( i ) \\ {N}_{m} ( i ) , & {f}_{m} \neq f ( i )\end{matrix}$$

where S and Nₘ(i) are signal and noise terms, both complex. The fading process γ(i) is complex-Gaussian. This result is more or less an ideal case, because it is likely that there will be at least a small amount of timing and/or frequency offset.

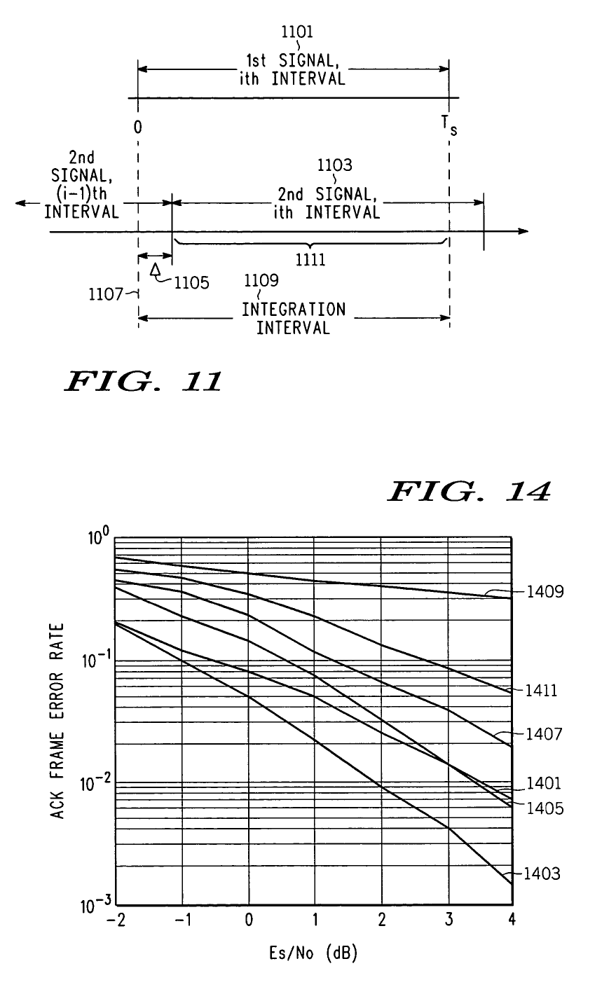

The effect of multiple paths will be investigated first by looking at the scenario in FIG. 11, where two Targets are sending ACK messages, i.e. a first Target sends a first signal 1101 and a second Target sends a second signal 1103, back to the Originator, with a propagation delay difference of Δ 1105 between the two signals. Also, assume that the timing synchronization algorithm of the receiver locks onto the signal 1101 that arrives first. Matched filtering will be done over a time interval with the first arriving signal serving as the reference 1107 for the beginning of the Integration interval 1109.

Next consider three cases. In all three, it will be assumed that the two signals arrive at the Originator at the same power level, and with no frequency offset. In the first case, i.e. Case 1, Δ=0 and the signals have the same data pattern. A tone at a certain frequency fₘ should ideally make a contribution to the mth matched filter, and should make no contributions to the other matched filters. If the first signal and second signal are at the same frequency f(i) during the ith interval, that is the transmitted symbols are the same, then Zₘ(i) from above becomes

$${Z}_{m} ( i ) = \{ \begin{matrix}( {γ}_{1} ( i ) + {γ}_{2} ( i ) ) S + {N}_{m} ( i ) , & {f}_{m} = f ( i ) \\ {N}_{m} ( i ) , & {f}_{m} \neq f ( i )\end{matrix}$$

where there are two independent complex-Gaussian fading processes, γ₁(i) and γ₂ (i), one for each signal. Note that this set of matched filter outputs would also result if a single ACK signal with twice the variance were sent. In other words, there is actually a 3 dB gain as a result of there being two ACK signals present, rather than a loss! Simulation results from FIG. 10 confirm that gain (see 1003 showing about a 3 dB improvement). Also notice that for 3 and 4 users present, there is a gain of 4.8 and 6 dB respectively (see 1005, 1007). This diversity gain makes intuitive sense, because the receiver is not looking at multiple signals interfering with each other, but is looking at multiple copies of the same signal, sent over independent paths.

In the second case, i.e. Case 2, Δ=0 and the signals have different data patterns. In this case, the two signals are at frequencies f⁽¹⁾(i) and f⁽²⁾(i) during the ith symbol interval, which are likely different frequencies. When they are different frequencies, the matched filter outputs become

$${Z}_{m} ( i ) = \{ \begin{matrix}{γ}_{1} ( i ) S + {N}_{m} ( i ) , & {f}_{m} = {f}^{( 1 )} ( i ) \\ {γ}_{2} ( i ) S + {N}_{m} ( i ) , & {f}_{m} = {f}^{( 2 )} ( i ) \\ {N}_{m} ( i ) , & otherwise\end{matrix}$$

and two of the M matched filters may have significant signal components. The two signals cannot be demodulated individually because each interferes with the other. It would be difficult, if not impossible, to pick out the two different signals without using training and channel tracking. From these two scenarios, although they are greatly simplified, it is clear that the Originator can more easily decode the composite signal if each of the two Targets sends the same signal.

In the third case, i.e. Case 3, Δ>0 and the signals have the same data patterns. Consider what happens when the two signals do not arrive at the Originator at the same time and assume that the timing synchronization locks onto the first signal. The integration interval 1109 of length Tₛ can be divided into two parts. During the first part 1105 of length Δ, the two signals will probably be at different frequencies, because the signals depend on f⁽¹⁾(i) and f⁽²⁾(i-1). But during the second part 1111 of length (Tₛ-Δ), the signals depend on f⁽¹⁾(i) and f⁽²⁾(i), which are expected to be the same.

Although the signals may interfere with each other during the first part of the integration interval, they will add constructively, on average, during the second part. If the value of Δ is small relative to a symbol time, the two signals will add constructively, on average, during the majority of the symbol interval, and will interfere with each other during a very small amount of the interval. However, if Δ is a relatively large part of a symbol interval, such as Δ=0.5 Tₛ, then the signals interfere with each other for a significant part of the interval. Details of the effect of this delay on performance will be more meaningful after the following discussion of the timing synchronization algorithm or process.

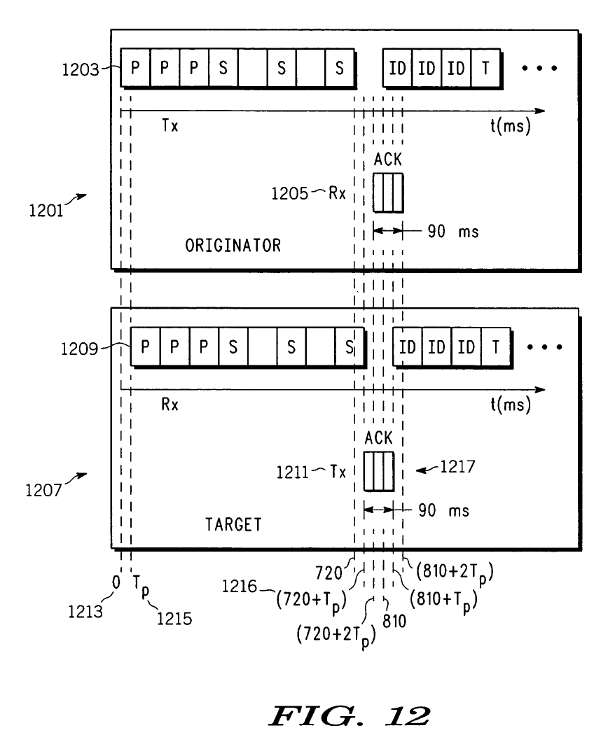

Referring to FIG. 12, a timing synchronization algorithm, practiced for example at the Originator, for estimating a time offset for each ACK slot will be discussed and described. This algorithm facilitates the ACK exchange, due to the Time Division Duplex (TDD) method for transmitting and receiving the ACK Slots, as illustrated in FIG. 12 where an Originator's 1201 transmit 1203 and receive 1205 stream and a Target's 1207 corresponding receive 1209 and transmit 1211 stream with a common time reference, t=0 1213 is depicted. The same algorithm may be used for Private and non-Private ACK, i.e. acknowledgment processes.

For ease of illustration, first consider Private ACK. The Originator begins transmission of the Preambles at time t=0 1213. Throughout reception of the Preambles and Sync Slots, the Target forms its own estimate of time, i.e. t=0. But in reality, there is a difference of Tₚ 1215 between the Originator and Target, i.e. the propagation delay from Originator to Target. Neither the Originator nor Target knows that delay Tₚ, because neither knows how far away the other is, physically.

When the Target has received the last Sync Slot 1216, 720 ms after the beginning of Preamble reception, it transmits ACK Slots 1217 back to the Originator. It is clear that the ACK Slots arrive at the Originator delayed by 2 Tₚ, from the diagram in FIG. 12 and since the propagation delay in each direction is nominally equal. For best performance, the Originator must estimate the two-way propagation delay, 2 Tₚ or time offset corresponding to propagation delay between the originating and target communication units.

The timing synchronization algorithm will be performed utilizing the 8-symbol Sync word, i.e. 8 symbol pattern [−7, −3, −7, −1 −3, −5, −5, −1], referred to 5 and FIG. 7. This Sync word may also be used in the Traffic slots. With a sampling rate of 15 samples/symbol, the 8 symbols of AGC ramp-up time occupy samples 0, 1 . . . 239 in the transmitted signal from the Originator. The Sync word occupies samples 240, 241 . . . 479. During reception of the ACK signal at the Originator, the signal arrives with a delay, such that the first sample of the Sync word is within some window, [240+N_{L},240+N_{U}], meaning that the two-way delay in samples is within the window [N_{L}, N_{U}]. This window will also include possible timing drift, which can be negative.

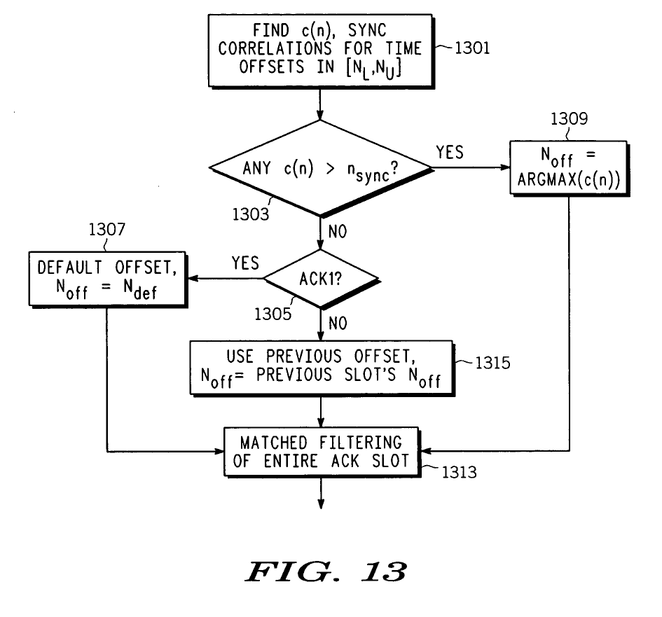

The Sync words will be used as shown in the flow diagram of FIG. 13, in a procedure for estimating a time offset between the Target(s) and Originator during the ACK slots. The three 30 ms ACK slots are denoted ACK1, ACK2, and ACK3. During ACK1, the Originator has no idea what the timing offset N_{off} (two-way propagation delay) will be, but assumes it will be within a small window, [N_{L}, N_{U}], in samples.

For each time offset in the window, the received signal is correlated with a time-shifted copy of a Sync word template 1301, to give a set of correlation values,
c(n), n=0,1, . . . ,(N_{U}−N_{L}+1)

The set of correlation values is then compared to a certain threshold η_{sync} 1303. Note that the threshold may vary as a function of signal strength and the like. A value for the threshold can be experimentally determined and should be chosen so that legitimate values of the correlations and thus possibly ACK messages are not discarded. A threshold value of 0.125 has been used in one exemplary embodiment. If none of the correlations are above η_{sync} and ACK1 is being processed, then a Sync hit did not occur, and the receiver uses an initial default time offset value N_{def} for its estimate \hat{N}_{off} 1307. If at least one of the correlation values is above η_{sync}, then the time offset corresponding to the largest or maximum of the correlations is used as \hat{N}_{off} 1309. Note that typically there will be just a single correlation value above η_{sync}, but it is possible to have more than one. Once the timing offset estimate has been determined, matched filtering of the symbols in the slot is performed in a known manner 1313 and the process repeats for ACK2 and ACK3.

During ACK2, the same absolute time window is used, regardless of what happened during ACK1. That is, the window will not be a window relative to the time offset found in ACK1, but will be the same absolute window [240+N_{L},240+N_{U}]. The same correlation procedure is used at 1301, but if no Sync hit occurs (method goes through 1305), then the timing offset estimate \hat{N}_{off} for ACK2 will be the value of \hat{N}_{off} used during ACK1 1315. During ACK3, this will be repeated, with the value of \hat{N}_{off} used in ACK2 as the estimate if no Sync hit occurs.

Simulation results of the timing synchronization algorithm will be presented for 2-user Non-Private ACK. First, the time window choice, i.e. relative difference in time between Originator and Target will be described, and then the results will be presented. For a good choice of the window [N_{L}, N_{U}], first consider the one-way propagation delay for a distance d,

$${T}_{p} = ( \frac{d ( meters )}{3 * {10}^{8} meters \text{/} sec} ) ( \frac{1000 meters}{0.6214 miles} ) = 5.36 μ sec \text{/} mile$$

The two-way delay is twice that number. With a symbol rate of 3200 symbols per second and with 15 samples/symbol, the receiver sampling time is

$${T}_{s} = ( \frac{1}{15 * 3200 samples \text{/} sec} ) = 20.833 μ sec$$

Thus each mile of distance between the Originator and a Target results in about a half sample of two-way delay at the Originator's receiver.

The lower point of the window N_{L} is chosen by considering a scenario in which the Originator and Target are very close together, to the point where the delay is just a small fraction of a sample. If there is a possibility of timing drift in the negative direction, perhaps the ACK signal could actually arrive with a timing offset of −1 sample. We will play it safe and allow for up to 2 samples of delay in the negative direction.

For the upper bound N_{U}, if the distance between Originator and Target is 24 miles, then there is about +12 samples of delay. If we again assume that there might be up to +1 sample of timing drift, then there could be +13 samples of delay. So the window will be [N_{L}, N_{U}]=[−2, +13] samples.

A default value of the timing offset N_{def} must be used in ACK1 if there is no Sync hit. Recall that for a spacing of 1 mile, there is about a half sample of delay, and one sample of delay for 2 miles of separation. Instead of a default value of 0 samples, it seems better to use a default of N_{def}=+1 sample, based, for example on an expected spacing of users of 2 miles or so.

Simulations were run for 2-user Non-Private ACK (Originator is receiving ACK signals from two Targets) operating in a Rayleigh fading channel at a speed of 3 mph. The fading process on each of ACK1, ACK2, and ACK3 was assumed independent, as a result of the frequency hopping. The window in the timing synchronization algorithm was [−2, +13], as described previously. The Sync threshold was 0.125. The frequency offsets between users were zero.

In the simulation results of FIG. 14, 2-user Non-Private ACK performance (ACK frame error rate on the vertical axis as a function of signal to noise on the horizontal axis) is shown, with the first path at a delay of zero samples and the second path delayed by 0 samples 1401, 4 samples 1403, 8 samples 1405, 12 samples 1407, 16 samples 1409. The users or Targets signals arrived at equal power at the Originator. For comparison, Private ACK, i.e. one Target, results 1411 are also shown.

Note that when the second path is delayed by 4 samples 1403, performance is better than when there is no delay on the second path 1401. The reason is that the signal envelope fluctuates up and down rapidly as a result of the timing offset. In a slow fading channel, like at 3 mph, the fading looks faster, and a diversity gain is realized, similar to the case of fast fading.

However, with 8 samples of delay on the second path 1405, performance is degraded with respect to the no delay case, for the reason described in Case 3 above. With the integration (correlation) performed over a symbol period and the two signals delayed by about half of a symbol with respect to each other, the second signal contributes an interference component. With 12 samples of delay between the paths 1407, the degradation is even higher. But it is encouraging to note that performance in both cases is still better than in Private ACK 1411.

When the delay between users is increased to 16 samples 1409, however, the reception falls apart, and floors out at a high value of FER. This is a result of the window size, which only extends up to 13 samples of delay. With the second path located outside of the window, the algorithm should lock onto the first path at zero delay every time. Then the second path is purely interference, and performance degrades.

In another simulation under similar conditions it was shown that the timing offset estimating algorithm as discussed above performed as well as a fixed time offset for small time offsets, e.g. 4 sample delay between 2 Targets and was significantly better for larger time offsets, e.g. for an 8 sample delay between 2 Targets approximately 2 dB improvement was realized. For a 12 sample delay a dramatic improvement was shown, e.g. without the timing estimate algorithm error rates well in excess of 20% with a floor just below 20% were observed whereas with the algorithm error rates below 10% and approaching 1% were observed.

What the timing offset estimating algorithm is doing in these cases is picking the stronger of the two paths during each ACK slot, and synchronizing to it. Recall that between hops, each individual ACK signal will experience independent fading. Thus it is common for a signal to be in a deep fade during one hop and not in a fade during the next hop. Also, it is common for the fading processes for each of the two Targets during a single hop to be very different in amplitude. When one of the two dominates, the timing algorithm should synchronize to it.

In summary, a method of setting up a call between an originating communication unit and one or more target communication units has been discussed and described. The method includes first exchanging a call setup message between the originating communication unit and the one or more target communication units, where the call setup message identifies at least one target communication unit and specifies a frequency hopping pattern that is pseudo-random and second exchanging an acknowledgment message between the at least one target communication unit and the originating communication unit, where the acknowledgment message from the at least one target communication unit is included in a signal that is transmitted according to the frequency hopping pattern. The method in certain embodiments also includes determining whether the acknowledgment message is present in a signal received, for example, on a plurality of sequential frequency hops according to the frequency hopping pattern. The call setup message can be sent or transmitted during one or more first time slots on one or more predetermined frequencies; and the method can include determining whether the acknowledgment message is present in a signal received during a plurality of second time slots, where each of the plurality of second time slots corresponds to a frequency determined by the frequency hopping pattern.

Note that the method can include sending the call setup message identifying a group of target communication units; and determining whether the acknowledgment message is present in a composite signal received according to the frequency hopping pattern where the composite signal comprises one or more signals from one or more of the group of target communication units. Determining whether the acknowledgment message is present in the composite signal can include determining whether the acknowledgment message is present in a plurality of signals from a corresponding plurality of target communication units, with the acknowledgment message included in each of the plurality of signals.

In certain embodiments, the method includes first exchanging the call setup message during a first time period; and second exchanging the acknowledgment message during a second time period, where the second time period is related to the first time period by a time difference comprising a predetermined number of time slots. The time difference can also include a time offset corresponding to a propagation delay between the originating communication unit and the at least one target communication unit. Then the time offset can be estimated by correlating information corresponding to the signal as received during the second time period with a template corresponding to the acknowledgment message, where the correlating is performed over a time window selected to account for the propagation delay to provide a plurality of correlations and associated offsets, and selecting an estimated time offset as the associated offset corresponding to a largest correlation.

The selecting may further comprise comparing each of the plurality of correlations to a threshold; when the threshold is satisfied, selecting the estimated time offset as the associated offset corresponding to the largest correlation; and when the threshold is not satisfied, selecting the estimated time offset as one of a default offset and a previously used offset. The estimating the time offset may be performed for each of a plurality of sequential time slots, e.g. each of the ACK slots in the ACK frame.

More specifically and in summary, in one-to-one communication, with traffic sent from Originator to Target, after an initial call establishment, the Target forms a bit field (ACK message) to be sent back to the Originator. The bit field contains information about whether the Target supports the intended call type, or, for example, a Version Number of the Target, or received signal strength information and the like. A symbol set is formed by processing the bit field as noted above, perhaps with procedures such as Cyclic Redundancy Check (CRC) coding, Forward Error Correction (FEC), repeat diversity, and time interleaving. A fixed training sequence to assist in timing estimation at the Originator is added to the symbol set. A symbol waveform is formed by modulating the symbol set. The symbol waveform is sent from the Target to the Originator during a time window after the initial call establishment, with both the Target and Originator knowing that the Target will be transmitting and the Originator will be receiving.

In one-to-many communication, with traffic sent from Originator to possibly multiple Targets, after an initial call establishment, the Targets that support the intended call type form a symbol set by using a pre-determined symbol set and adding a fixed training sequence to assist in timing estimation at the Originator. A symbol waveform is formed by modulating the symbol set. For the Targets that support the intended call type, the symbol waveform is sent to the Originator during a time window after the initial call establishment, with both the Targets and Originator knowing that the Targets will be transmitting and the Originator will be receiving.

In one-to-one and in one-to-many communication, during reception of an ACK message sent on a single frequency hop, the Originator forms a set of correlation values by correlating the received signal with time-shifted versions of a known template. The time-shifted versions of the template correspond to positive and negative shifts by integer numbers of samples with respect to a fixed time reference. The Originator forms a timing estimate for the reception based on the maximum of the correlation values, provided that the maximum correlation value is greater than an established threshold. If the maximum correlation value is not greater than the established threshold, a pre-determined default value is used.

In one-to-one and in one-to-many communication, during reception of an ACK message sent on multiple frequency hops, and during the reception of the ACK message on hops beyond the first hop, the Originator operates as noted above and if the maximum correlation value is not greater than the established threshold, the timing estimate from the previous hop is used.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A communication unit arranged and constructed to detect acknowledgment messages on a time division channel, the communication unit comprising:
a transceiver configured to support air interfaces with other communication units according to frequency hopping patterns;
a controller coupled to and cooperatively controlling the transceiver to:
send a call setup message identifying at least one target communication unit, the call setup message further indicating a pseudo-random frequency hopping pattern; and
determine whether an acknowledgment message from the at least one target communication unit is present in a signal received according to the pseudo-random frequency hopping pattern.

2. The communication unit of claim 1 wherein the controller cooperatively with the transceiver is configured to determine whether the acknowledgment message is present in a signal received on a plurality of sequential frequency hops according to the pseudo-random frequency hopping pattern.

3. The communication unit of claim 1 wherein the controller cooperatively with the transceiver is configured to:
send the call setup message during one or more first time slots on a predetermined frequency; and
determine whether the acknowledgment message is present in a signal received during a plurality of second time slots, each of the plurality of second time slots corresponding to a frequency determined by the pseudo-random frequency hopping pattern.

4. The communication unit of claim 1 wherein the controller cooperatively with the transceiver is configured to:
send the call setup message identifying a group of target communication units; and
determine whether the acknowledgment message is present by determining whether the acknowledgment message is present in a composite signal received according to the pseudo-random frequency hopping pattern and comprising one or more signals from one or more of the group of target communication units.

5. The communication unit of claim 4 wherein the controller cooperatively with the transceiver is configured to determine whether the acknowledgment message is present in the composite signal, the composite signal further comprising a plurality of signals from a corresponding plurality of target communication units, the acknowledgment message included in each of the plurality of signals.

6. The communication unit of claim 1 wherein the controller cooperatively with the transceiver is configured to:
send the call setup message during a first time period; and
determine whether the acknowledgment message is present during a second time period, the second time period related to the first time period by a time difference comprising a predetermined number of time slots.

7. The communication unit of claim 6 wherein the time difference further comprises a time offset corresponding to a propagation delay between the communication unit and the at least one target communication unit and the controller is configured to:
estimate the time offset by correlating information corresponding to the signal as received during the second time period with a template corresponding to the acknowledgment message, the correlating performed over a time window selected to account for the propagation delay to provide a plurality of correlations and associated offsets with an estimated time offset selected as the associated offset corresponding to a largest correlation.

8. The communication unit of claim 7 wherein the controller is further configured to compare each of the plurality of correlations to a threshold and when the threshold is satisfied, to select the estimated time offset as the associated offset corresponding to the largest correlation and otherwise to select the estimated time offset as one of a default offset and a previously used offset.

9. The communication unit of claim 8 wherein the controller is further configured to estimate the time offset for each of a plurality of sequential time slots.

10. A method of setting up a call between an originating communication unit and one or more target communication units, the method comprising:
first exchanging a call setup message between the originating communication unit and the one or more target communication units, the call setup message identifying at least one target communication unit and specifying a frequency hopping pattern that is pseudo-random; and
second exchanging, responsive to the call setup message, an acknowledgment message between the at least one target communication unit and the originating communication unit, the acknowledgment message from the at least one target communication unit included in a signal that is transmitted according to the frequency hopping pattern.

11. The method of claim 10 further comprising determining whether the acknowledgment message is present in a signal received on a plurality of sequential frequency hops according to the frequency hopping pattern.

12. The method of claim 10 further comprising:
sending the call setup message during one or more first time slots on at least one predetermined frequency; and
determining whether the acknowledgment message is present in a signal received during a plurality of second time slots, each of the plurality of second time slots corresponding to a frequency determined by the frequency hopping pattern.

13. The method of claim 10 further comprising:
sending the call setup message identifying a group of target communication units; and
determining whether the acknowledgment message is present in a composite signal received according to the frequency hopping pattern and comprising one or more signals from one or more of the group of target communication units.

14. The method of claim 13 wherein the determining whether the acknowledgment message is present in the composite signal, further comprises determining whether the acknowledgment message is present in a plurality of signals from a corresponding plurality of target communication units, the acknowledgment message included in each of the plurality of signals.

15. The method of claim 10 wherein:
the first exchanging the call setup message occurs during a first time period; and
the second exchanging the acknowledgment message occurs during a second time period, the second time period related to the first time period by a time difference comprising a predetermined number of time slots.

16. The method of claim 15 wherein the time difference further comprises a time offset corresponding to a propagation delay between the originating communication unit and the at least one target communication unit and the method further comprises:
estimating the time offset by;
correlating information corresponding to the signal as received during the second time period with a template corresponding to the acknowledgment message, the correlating performed over a time window selected to account for the propagation delay to provide a plurality of correlations and associated offsets, and
selecting an estimated time offset as the associated offset corresponding to a largest correlation.

17. The method of claim 16 further comprising:
comparing each of the plurality of correlations to a threshold;
when the threshold is satisfied, selecting the estimated time offset as the associated offset corresponding to the largest correlation; and
when the threshold is not satisfied, selecting the estimated time offset as one of a default offset and a previously used offset.

18. The method of claim 16 wherein the estimating the time offset is further performed for each of a plurality of sequential time slots.

19. A communication unit arranged and constructed to provide acknowledgment messages on a time division channel, the communication unit comprising:
a transceiver configured to support air interfaces with other communication units according to frequency hopping patterns;
a controller coupled to and cooperatively controlling the transceiver to:
receive a call setup message;
determine whether the call setup message identifies the communication unit and determine a pseudo-random frequency hopping pattern specified by the call setup message; and
only when the call setup message identifies the communication unit send an acknowledgment message responsive to the call setup message, the acknowledgment message included in a signal that is transmitted according to the pseudo-random frequency hopping pattern.

20. The communication unit of claim 19 wherein controller cooperatively controlling the transceiver is configured to receive the call setup message on a predetermined frequency during a first time period and send the acknowledgment message during a second time period comprising a sequence of consecutive time slots, where a frequency for the signal during each time slot is determined according to the pseudo-random frequency hopping pattern.
